(19) United States
(12) Patent Application Publication
(10) Pub. No.: US 2009/0027595 A1
(43) Pub. Date: Jan. 29, 2009

(54) SEMICONDUCTOR INTEGRATED CIRCUIT DEVICE, DISPLAY DEVICE AND ELECTRIC CIRCUIT

(75) Inventor: Takehiro TAKAHASHI, Tokyo (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/178,706

(22) Filed: Jul. 24, 2008

(30) Foreign Application Priority Data
Jul. 24, 2007 (JP) 2007-191937

(51) Int. Cl. G02F 1/133

(52) U.S. Cl. 349/73

(57) ABSTRACT

A semiconductor integrated circuit is provided which is able to capture initialization data as a base point of a cascade connection path and is able to capture initialization data supplied from the upstream of the cascade connection path. The semiconductor integrated circuit has a system interface terminal and an extension interface terminal used for input and output of initialization data. The semiconductor integrated circuit is able to select a first initializing operation of storing internally initialization data included in system interface information input from the system interface terminal and outputting the system interface information from the extension interface terminal to the outside of the semiconductor integrated circuit, or a second initializing operation of storing internally initialization data included in system interface information input from the extension interface terminal and outputting the system interface information from the extension interface terminal to the outside of the semiconductor integrated circuit.

### CROSS-REFERENCE TO RELATED APPLICATION

The present application claims priority from Japanese patent application No. 2007-191937 filed on Jul. 24, 2007, the content of which is hereby incorporated by reference into this application.

### BACKGROUND OF THE INVENTION

The present invention relates to a technology of taking initialization data into a semiconductor integrated circuit, further to a path control technology of supplying initialization data to a plurality of semiconductor integrated circuits for display drive control according to the display size and display characteristic of a display unit mounted on a display device, and to a technology of setting initialization data into a plurality of control semiconductor integrated circuits mounted on an electronic circuit, and the present invention relates to a technology which is useful, for example, to be applied to an active matrix liquid crystal display panel.

A plurality of driver LSIs are arranged in parallel in a liquid crystal panel having a relatively large display size of a personal computer, a portable information terminal, or the like. Technologies of cascading a plurality of driver LSIs arranged in parallel and supplying data to the driver LSIs in series are described in Japanese Unexamined Patent Publication No. 2004-205901 (Patent Document 1) and Japanese Unexamined Patent Publication No. 2003-60061 (Patent Document 2). Data supplied in series in Patent Document 1 is display data. Data supplied in series in Patent Document 2 is a command.

### SUMMARY OF THE INVENTION

However, the present inventor found out that when driver LSIs are cascaded and display data or a command is supplied to the driver LSIs in series, if the resistance of wirings for cascade connection of the driver LSIs are large, the transfer rate is small and it is difficult to increase the display operating frequency. For example, in a liquid crystal panel with a chip-on-glass (COG) structure, a compound wiring pattern pervious to visible light typified by an indium tin oxide (ITO) wiring is used as a wiring pattern on a glass substrate. Since the visible light transmittance of a compound wiring pattern is as high as the order of 90%, compound wiring patterns are frequently used for electrodes and wiring patterns of a liquid crystal panel and an organic EL panel. When driver LSIs are mounted on a glass substrate, bump electrodes of the driver LSIs are coupled to ITO wirings using anisotropy conductive films (ACFs) or the like. At that time, ITO wirings are also used as a matter of course for cascade connection of driver LSIs. ITO wiring patterns have significantly higher resistances than those of copper wirings and the like of a flexible substrate (FPC substrate). Because of the higher resistances, wide ITO wiring patterns should be formed, but there is a limit for this.

It has not been considered in the Patent Documents but has been found out by the present inventor that such a higher speed than that for a display operation is not required for an initialization data input operation when initialization data for initialization of a driver LSI must be input to the driver LSI in addition to display drive data.

Furthermore, driver LSIs mounted on a liquid crystal panel with a COG structure are connected to a host system by coupling ITO wiring patterns coupled to external terminals of the driver LSIs to wiring patterns of a flexible substrate by ACFs. In consideration of this, when a plurality of driver LSIs is cascaded, it is not necessarily required that necessary information must be supplied to the driver LSIs with an end of the cascade connection as the base point. In contrast, it is useful for increasing flexibility in the formation of connection between a liquid crystal panel and a host system and flexibility in the structure of a FPC substrate that necessary information for the base point can be supplied to cascaded driver LSIs from any one of them.

An object of the present invention is to provide a semiconductor integrated circuit which is able to capture initialization data as a base point of a cascade connection path and is able to capture initialization data supplied from the upstream of the cascade connection path.

Another object of the present invention is to provide a display device allowing a simple wiring path for supply of initialization data without decreasing the speed of the display operation.

Still another object of the present invention is to provide an electronic circuit allowing a simple wiring path for supply of initialization data without decreasing the speed of a processing operation for processing data.

The above and further objects and novel features of the present invention will be apparent from the following description of this specification and the accompanying drawings.

Outline of a typical one of inventions disclosed in this application will be briefly described below.

A semiconductor integrated circuit according to this invention has a system interface terminal and an extension interface terminal which are used for input and output of initialization data. The semiconductor integrated circuit is configured capable of selecting a first initializing operation of storing internally initialization data included in system interface information input from the system interface terminal and outputting the system interface information from the extension interface terminal to the outside of the semiconductor integrated circuit, or a second initializing operation of storing internally initialization data included in system interface information input from the extension interface terminal and outputting the system interface information from the extension interface terminal to the outside of the semiconductor integrated circuit.

An effect obtained by a typical one of inventions disclosed in this application will be briefly described below.

The semiconductor integrated circuit is able to capture initialization data as a base point of a cascade connection path by selecting the first initializing operation, and is able to capture initialization data supplied from the upstream of the cascade connection path by selecting the second initializing operation.

### BRIEF DESCRIPTION OF THE DRAWINGS

FIG. 1 is a block diagram illustrating a schematic configuration of a liquid crystal display panel;

FIG. 2 is a block diagram exemplifying the configuration of a source driver;

FIG. 3 is a block diagram exemplifying the configuration of a gate driver;

FIG. 4 is a plan view exemplifying the formation of connection by ITO wiring patterns;

FIG. 5 is an explanatory diagram of illustrating an example of mode setting for source drivers when only one master source driver is system-interfaced;

FIG. 6 is an explanatory diagram of illustrating an example of mode setting for source drivers when all of the source drivers are allowed to perform a master operation to be system-interfaced;

FIG. 7 is an explanatory diagram of illustrating an example of mode setting for source drivers when only one master source driver is system-interfaced through an EEPROM;

FIG. 8 is an explanatory diagram of illustrating the state of setting an EEPROM write mode for one master driver;

FIG. 9 is an explanatory diagram of illustrating the state of setting a master operation for any one of the center, right, and left source driver of three source drivers;

FIG. 10 is an explanatory diagram of exemplifying the state of setting of source drivers when the number of the cascaded source drivers is four or more;

FIG. 11 is an explanatory diagram of using two source drivers in cascade connection; and

FIG. 12 is an explanatory diagram of forming a liquid crystal panel using one source driver.

### DETAILED DESCRIPTION OF THE PREFERRED EMBODIMENTS

### 1. Outline of Embodiments

First, the outline of typical embodiments of the present invention disclosed in this application will be described. Reference numerals in figures referred with parentheses in the outline description about the typical embodiments indicate only examples included in concepts of components to which the reference numerals are attached.

[1] A semiconductor integrated circuit (6) includes a first external interface circuit (30) which receives processing data from the outside of the semiconductor integrated circuit, a processing circuit (40) which processes the processing data, a storage circuit (50) capable of holding initialization data, a control circuit (60, 61) controlling the operation of the processing circuit on the basis of the initialization data held by the storage circuit, and a second external interface circuit (70). The second external interface circuit has a first interface terminal group (T-HST) (system interface terminal group) and a pair of second interface terminal groups (T-EXTN1, T-EXTN2) (extension interface terminal groups) which are external terminals of the semiconductor integrated circuit. The second external interface circuit is able to select a first initializing operation or a second initializing operation. The first initializing operation is an operation of writing initialization data included in system interface information input from the system interface terminal group into the storage circuit and outputting the system interface information from the extension interface terminal groups to the outside of the semiconductor integrated circuit. The second initializing operation is an operation of writing initialization data included in system interface information input from one of the extension interface terminal groups into the storage circuit and outputting the system interface information from the other one of the extension interface terminal groups to the outside of the semiconductor integrated circuit.

The semiconductor integrated circuit is able to capture initialization data as a base point of a cascade connection path by selecting the first initializing operation. Furthermore, the semiconductor integrated circuit is able to capture initialization data supplied from the upstream of a cascade connection path by selecting the second initializing operation.

[2] In the semiconductor integrated circuit of item 1, the second external interface circuit has a first mode terminal (SYSMS) which is an external terminal of the semiconductor integrated circuit, and the second external interface circuit selects the first initializing operation when the first mode terminal is in a predetermined state, and selects the second initializing operation when the first mode terminal is in any other state.

[3] In the semiconductor integrated circuit of item 2, the second external interface circuit outputs system interface information from both of the pair of extension interface terminal groups in the first initializing operation.

The semiconductor integrated circuit which has selected the first initializing operation is able to capture initialization data and supply it to the downstream as a base point at any one of a base end and an intermediate point of a cascade connection path. The formation of outputting system interface information from the extension interface terminal groups may be a formation of outputting it in both directions, one direction, or the other direction selected by a mode signal in addition to being fixed to a formation of outputting it in both directions described above. In this case, mode terminals for two bits are required.

[4] In the semiconductor integrated circuit of item 3, the second external interface circuit has a second mode terminal (ILR) which is an external terminal of the semiconductor integrated circuit. The second external interface circuit is able to switch assignment of input and output to the second interface terminal groups according to the state of the second mode terminal, the assignment allowing one of the second interface terminal groups to be used as an input terminal group for the system interface information and allowing the other one of the second interface terminal groups to be used as an output terminal group for the system interface information in the second initializing operation.

[5] A semiconductor integrated circuit (6) includes a first external interface circuit (30) for receiving drive data from the outside of the semiconductor integrated circuit, a drive circuit (40) outputting a drive signal on the basis of the drive data supplied from the first external interface circuit, a storage circuit (50) capable of holding initialization data, a control circuit (60, 61) controlling the drive signal output operation of the drive circuit on the basis of the initialization data held by the storage circuit, and the second external interface circuit (70). The second external interface circuit has a system interface terminal group (T-HST) and a pair of extension interface terminal groups (T-EXTN1, T-EXTN2) which are external terminals of the semiconductor integrated circuit. The second external interface circuit is able to select a first initializing operation or a second initializing operation. The first initializing operation is an operation of writing initialization data included in system interface information input from the system interface terminal group into the storage circuit and outputting the system interface information from the extension interface terminal groups to the outside of the semiconductor integrated circuit. The second initializing operation is an operation of writing initialization data included in system interface information input from the outside of the semiconductor integrated circuit to one of the extension interface terminal groups into the storage circuit and outputting the system interface information from the other one of the extension interface terminal groups to the outside of the semiconductor integrated circuit.

The semiconductor integrated circuit is able to capture initialization data as a base point of a cascade connection path by selecting the first initializing operation. Furthermore, the semiconductor integrated circuit is able to capture initialization data supplied from the upstream of the cascade connection path by selecting the second initializing operation.

[6] In the semiconductor integrated circuit of item 5, the second external interface circuit has a third mode terminal (ESEL) which is an external terminal of the semiconductor integrated circuit. The second external interface circuit selects an SPI-based serial input interface function or an SPI-based memory access interface function, according to the state of the third mode terminal, as an interface mode for the system interface information. The semiconductor integrated circuit is able to directly receive system interface information through a serial interface from a host system, with a serial peripheral interface (SPI) which requires little number of interface terminals, and is able to capture system interface information previously written into a memory such as a serial EEPROM by the host system by memory access.

[7] In the semiconductor integrated circuit of item 6, the second external interface circuit has a chip-selection terminal (CSX), a data input terminal (SDI), a data output terminal (SDO), and a clock terminal (SCK) for defining the timing of capturing data from the data input terminal.

[8] In the semiconductor integrated circuit of item 7, the second external interface circuit has a fourth mode terminal (EEP) which is an external terminal of the semiconductor integrated circuit. The second external interface circuit allows the SPI-based memory read access when the fourth mode terminal is in a predetermined state and makes the system interface terminal high impedance when the fourth mode terminal is in any other state. When writing system interface information into the serial EEPROM or the like in advance, the second external interface circuit selects the operation of making the interface function by the system interface terminal impossible. For this reason, a malfunction that the system interface circuit directly captures write access information to a serial EEPROM or the like can be prevented.

[9] In the semiconductor integrated circuit of item 8, the second external interface circuit has a first mode terminal (SYSMS) which is an external terminal of the semiconductor integrated circuit. The second external interface circuit selects the first initializing operation or the second initializing operation according to the state of the first mode terminal.

[10] In the semiconductor integrated circuit of item 9, the second external interface circuit includes a first extension interface terminal group (T-EXTN1) and a second extension interface terminal group (T-EXTN2) as the pair of extension interface terminal groups. The second external interface circuit outputs system interface information from both of the first extension interface terminal group and the second extension interface terminal group in the first initializing operation.

[11] In the semiconductor integrated circuit of item 10, the second external interface circuit has a second mode terminal (ILR) which is an external terminal of the semiconductor integrated circuit. The second external interface circuit selects a state that system interface information is input from the first extension interface terminal group and the input system interface information is output from the second extension interface terminal group, or a state that system interface information is input from the second extension interface terminal group and the input system interface information is output from the first extension interface terminal group, according to the state of the second mode terminal, in the second initializing operation.

[12] In the semiconductor integrated circuit of item 11, the first extension interface terminal group includes a first chip-selection signal input/output terminal (CCS1) used for input and output of a chip selection signal, a first data input/output terminal (CDT1) used for input and output of initialization data, a first clock-signal input/output terminal (CSK1) used for input and output of a clock signal, and a first chip-selection signal output terminal (GCS1) used for output of a chip selection signal. The second extension interface terminal group includes a second chip-selection signal input/output terminal (CCS2) used for input and output of a chip selection signal, a second data input/output terminal (CDT2) used for input and output of initialization data, a second clock-signal input/output terminal (CSK2) used for input and output of a clock signal, and a second chip-selection signal output terminal (GCS2) used for output of a chip selection signal. The first and second chip-selection signal output terminals (CCS1, CCS2) are used for transmission of a chip-selection signal between the cascaded semiconductor integrated circuits. The first and second chip-selection signal output terminals (GCS1, GCS2) are used as output terminals for a chip-selection signal to, for example, a semiconductor integrated circuit different from the aforementioned semiconductor integrated circuit. When the second mode terminal is in a predetermined state, the first chip-selection signal input/output terminal, the first data input/output terminal, and the first clock-signal input/output terminal are used as signal input terminals, the first chip-selection signal output terminal is used as a fixed-level output terminal, and the second chip-selection signal input/output terminal, the second data input/output terminal, the second clock-signal input/output terminal, and the second clock-signal output terminal are used as signal output terminals. When the second mode terminal is in any other state, the second chip-selection signal input/output terminal, the second data input/output terminal, and the second clock-signal input/output terminal are used as signal input terminals, the second chip-selection signal output terminal is used as a fixed-level output terminal, and the first chip-selection signal input/output terminal, the first data input/output terminal, the first clock-signal input/output terminal, and the first chip-selection signal output terminal are used as signal output terminals.

[13] In the semiconductor integrated circuit of item 12, the control circuit has a first timing output terminal (GSTP1, GCLK1) and a second timing output terminal (GSTP2, GCLK2) which are used for output of a timing signal synchronizing with the drive timing of the drive circuit to the outside of the semiconductor integrated circuit, and is able to select any one of a state of outputting the timing signal from the first timing output terminal, a state of outputting the timing signal from the second timing output terminal, and a state of not outputting the timing signal from any of the first timing output terminal and the second timing output terminal, according to predetermined initialization data stored in the storage circuit. Only one semiconductor integrated circuit at the lower downstream of cascaded semiconductor integrated circuits is able to output a timing signal to a different semiconductor integrated circuit, so that it is possible to prevent a noise caused by unnecessary timing signal output of the other cascaded semiconductor integrated circuits.

[14] In the semiconductor integrated circuit of item 13, the storage circuit has a storage area for storing display size data and γ correction data as the initialization data. In the case of a semiconductor integrated circuit driving a liquid crystal panel, the driving can be optimized for the size and display characteristic of the liquid crystal panel to be driven.

[15] In a display device (1), a plurality of first semiconductor integrated circuits (6) driving a plurality of signal electrodes of an active matrix display (3) and a second semiconductor integrated circuit (7) driving a plurality of scanning electrodes of the display are mounted in a panel substrate (2) which has first to third compound wiring patterns pervious to visible light and in which the display is formed. The first semiconductor integrated circuits and the second semiconductor integrated circuit are allowed to couple to a host system through wirings (15, 16) of a flexible wiring substrate (13) coupled to the first and second compound wiring patterns (8, 9). One end of the first compound wiring pattern (8) is coupled to a wiring (15) over the flexible wiring substrate to which display data is supplied from the host system, and the other end of the first compound wiring pattern is coupled to each of the first semiconductor integrated circuits in parallel. One end of the second compound wiring pattern (9) is coupled to a wiring (16) over the flexible wiring substrate to which system interface information including initialization data for display control is supplied from the host system, and the other end of the second compound wiring pattern is coupled to predetermined one of the first semiconductor integrated circuits. The third compound wiring pattern (12) couples the first semiconductor integrated circuits with the second semiconductor integrated circuit in series, and system interface information received by the predetermined one of the first semiconductor integrated circuits is supplied to the other of the first semiconductor integrated circuits and the second semiconductor integrated circuit in series through the third compound wiring pattern.

Display data is supplied to each of the first semiconductor integrated circuits in parallel through the first compound wiring patterns, so that a high-speed display operation is possible. Supply of initialization data for a initializing operation to which a high speed is not required as compared with display operation is performed using the third compound wiring pattern for cascade connection between the first and second semiconductor integrated circuits, so that one of cascaded first semiconductor integrated circuits is made a base point for supply of the initialization data to them and the initialization data may be supplied to the one of first semiconductor integrated circuits from the host system using the first compound wiring pattern. Thus, the number of connection points between the wiring pattern on the flexible wiring substrate and the compound wiring patterns on the panel substrate for supply of the initialization data can be reduced. If the number of connection points is reduced, it becomes easy to increase the widths of the compound wiring patterns in the connection portions and it becomes easy to reduce the resistance of the compound wiring patterns. Furthermore, one of the cascaded first semiconductor integrated circuits may be made a base point of supply of the initialization data for them, so that flexibility in the formation of connection between the display panel substrate and the host system and flexibility in the wiring structure of the flexible substrate can be increased.

[16] In the display device of item 15, the compound wiring patterns pervious to visible light are indium tin oxide (ITO) wiring patterns.

[17] In the display device of item 16, the panel substrate is made of glass or polyethylene terephthalate. For example, glass is used for a liquid crystal panel, and polyethylene terephthalate is used for an electronic paper.

[18] In the display device of item 15, a nonvolatile memory (21) into which initialization data for display control is allowed to be written is provided at an intermediate point of the wiring on the flexible wiring substrate to which system interface information including initialization data for display control is supplied from the host system. The first semiconductor integrated circuits coupled to the second compound wiring pattern are able to directly receive system interface information from the host system through serial interface or the like. However, if the nonvolatile memory is disposed, the first semiconductor integrated circuits are able to access the nonvolatile memory and capture system interface information which has been previously written in the nonvolatile memory by the host system.

[19] In the display device of item 18, each of the first semiconductor integrated circuits has an SPI-based serial input interface mode and an SPI-based memory access interface mode which can be selected as a host interface mode of receiving interface information from a host system.

[20] In the display device of item 15, each of the first semiconductor integrated circuits (6) includes a first external interface circuit (30) coupled to the first compound wiring pattern (8), a drive circuit (40) driving the signal electrodes on the basis of processing data supplied from the first external interface circuit, a storage circuit (50) capable of holding the initialization data, a control circuit (60, 61) controlling the operation of the drive circuit on the basis of the initialization data held by the storage circuit, and a second external interface circuit (70) having a system interface terminal group (T-HST) and a pair of extension interface terminal groups (T-EXTN1, T-EXTN2) as external terminals of the first semiconductor integrated circuit. The second external interface circuit of the predetermined one of the first semiconductor integrated circuits selects a first initializing operation of writing initialization data included in system interface information input from the second compound wiring pattern (9) to the system interface terminal into the storage circuit and outputting the system interface information from the extension interface terminal groups to the third compound wiring pattern (12). The second external interface circuit of the other of the first semiconductor integrated circuits selects a second initializing operation of writing initialization data included in system interface information input from the third compound wiring pattern to one of the extension interface terminal groups into the storage circuit and outputting the system interface information from the other of the extension interface terminal groups to the third compound wiring pattern.

[21] In the display device of item 20, each of the first semiconductor integrated circuits has a first mode terminal (SYSMS) which is an external terminal. The second external interface circuit selects the first initializing operation or the second initializing operation according to the state of the first mode terminal.

[22] In the display device of item 21, the second external interface circuit includes a first extension interface terminal group and a second extension interface terminal group as the pair of extension interface terminal groups. The first semiconductor integrated circuit which has selected the first initializing operation outputs the system interface information from both of the first extension interface terminal group and the second extension interface terminal group to the third compound wiring pattern.

[23] In the display device of item 22, the third compound wiring pattern coupled to each of the first extension interface terminal group and second extension interface terminal group of one of the first semiconductor integrated circuits is divided between the first extension interface terminal group and the second extension interface terminal group. Thus, the impedance of the third compound wiring pattern can be reduced.

[24] In the display device of item 22, each of the first semiconductor integrated circuits has a second mode terminal (ILR) which is an external terminal. Each of the first semiconductor integrated circuits for which the second initializing operation has been selected selects a state that system interface information is input from the first extension interface terminal group and the input system interface information is output from the second extension interface terminal group, or a state that system interface information is input from the second extension interface terminal group and the input system interface information is output from the first extension interface terminal group, according to the state of the second mode terminal, in the second initializing operation.

[25] In a display device (1), a plurality of control semiconductor integrated circuits (6) controlling an image display unit (3) are provided in a panel substrate (2) which has first to third compound wiring patterns pervious to visible light and in which the image display unit is formed, and the control semiconductor integrated circuits are allowed to couple to a host system through the compound wiring patterns. The first compound wiring pattern (8) receives control data supplied from the host system and is coupled to each of the control semiconductor integrated circuits in parallel. The second compound wiring pattern (9) receives system interface information including initialization data from the host system, and is coupled to predetermined one of the control semiconductor integrated circuits. The third compound wiring pattern (12) couples the control semiconductor integrated circuits in series, and system interface information received by the predetermined one of the control semiconductor integrated circuits is supplied to the other of the control semiconductor integrated circuits in series through the third compound wiring pattern.

[26] In the display device of item 25, the compound wiring patterns pervious to visible light are ITO (Indium Tin Oxide) wiring patterns.

[27] In the display device of item 26, the panel substrate is made of glass or polyethylene terephthalate.

[28] In the display device of item 25, each of the control semiconductor integrated circuits (6) includes a first external interface circuit (30) coupled to the first compound wiring pattern, a processing circuit (40) which processes control data supplied from the first external interface circuit, a storage circuit (50) capable of holding the initialization data, a control circuit (60, 61) controlling the operation of the processing circuit on the basis of the initialization data held by the storage circuit, and a second external interface circuit (70) having a system interface terminal group and a pair of extension interface terminal groups as external terminals of the control semiconductor integrated circuit. The second external interface circuit of the predetermined one of the control semiconductor integrated circuits selects a first initializing operation of writing initialization data included in system interface information input from the second compound wiring pattern to the system interface terminal into the storage circuit and outputting the system interface information from the extension interface terminal to the third compound wiring pattern. The second external interface circuit of the other of the control semiconductor integrated circuits selects a second initializing operation of writing initialization data included in system interface information input from the third compound wiring pattern to one of the extension interface terminal groups into the storage circuit and outputting the system interface information from the other of the second interface terminal groups to the third compound wiring pattern.

[29] In the display device of item 28, each of the control semiconductor integrated circuits has a first mode terminal which is an external terminal. The second external interface circuit selects the first initializing operation or the second initializing operation according to the state of the first mode terminal.

[30] In the display device of item 29, the second external interface circuit includes a first extension interface terminal group and a second extension interface terminal group as the pair of extension interface terminal groups. The predetermined one of the control semiconductor integrated circuits which has selected the first initializing operation outputs the system interface information from both of the first extension interface terminal group and the second extension interface terminal group to the third compound wiring pattern.

[31] In the display device of item 30, the third compound wiring pattern coupled to each of the first extension interface terminal group and the second extension interface terminal group of one of the control semiconductor integrated circuits is divided between the first extension interface terminal group and the second extension interface terminal group.

[32] In the display device of item 31, each of the control semiconductor integrated circuits has a second mode terminal which is an external terminal. Each of the control semiconductor integrated circuits selects a state that system interface information is input from the first extension interface terminal group and the input system interface information is output from the second extension interface terminal group, or a state that system interface information is input from the second extension interface terminal group and the input system interface information is output from the first extension interface terminal group, according to the state of the second mode terminal, in the second initializing operation.

[33] In an electronic circuit (1), a plurality of control semiconductor integrated circuits (6, 7) is provided in a substrate (2) having first to third wiring patterns, and initialization data and processing data are allowed to be supplied from a host system to the control semiconductor integrated circuits through the first to third wiring patterns. The first wiring pattern (8) receives processing data supplied from the host system and is coupled to each of the control semiconductor integrated circuits in parallel. The second wiring pattern (9) receives initialization data from the host system and is coupled to predetermined one of the control semiconductor integrated circuits. The third wiring pattern (12) couples the control semiconductor integrated circuits in series, and initialization data received by the predetermined one of the control semiconductor integrated circuits is supplied to the other of the control semiconductor integrated circuits in series through the third wiring pattern.

[34] In the electronic circuit of item 33, the wiring patterns are ITO (Indium Tin Oxide) wiring patterns.

[35] In the electronic circuit of item 34, the substrate is made of glass or polyethylene terephthalate.

[36] In the electronic circuit of item 33, each of the control semiconductor integrated circuits includes a first external interface circuit coupled to the first wiring pattern, a processing circuit which processes processing data supplied from the first external interface circuit, a storage circuit capable of holding the initialization data, a control circuit controlling the operation of the processing circuit on the basis of the initialization data held by the storage circuit, and a second external interface circuit having a system interface terminal group and a pair of extension interface terminal groups as external terminals of the control semiconductor integrated circuit. The second external interface circuit of the predetermined one of the control semiconductor integrated circuits selects a first initializing operation of writing initialization data input from the second wiring pattern to the system interface terminal group into the storage circuit and outputting the initialization data from the extension interface terminal groups to the third wiring pattern. The second external interface circuit of the other of the control semiconductor integrated circuits select a second initializing operation of writing initialization data input from the third wiring pattern to one of the extension interface terminal groups into the storage circuit and outputting the initialization data from the other of the extension interface terminal groups to the third wiring pattern.

[37] In the electronic circuit of item 36, each of the control semiconductor integrated circuits has a first mode terminal which is an external terminal. The second external interface circuit selects the first initializing operation or the second initializing operation according to the state of the first mode terminal.

[38] In the electronic circuit of item 37, the second external interface circuit includes a first extension interface terminal group and a second extension interface terminal group as the pair of extension interface terminal groups. The predetermined one of the control semiconductor integrated circuits which has selected the first initializing operation outputs the initialization data from both of the first extension interface terminal group and the second extension interface terminal group to the third wiring pattern.

[39] In the electronic circuit of item 38, the third wiring pattern coupled to each of the first extension interface terminal group and second extension interface terminal group of one of the control semiconductor integrated circuits is divided between the first extension interface terminal group and the second extension interface terminal group.

[40] In the electronic circuit of item 39, each of the control semiconductor integrated circuits has a second mode terminal which is an external terminal. Each of the control semiconductor integrated circuits selects a state that initialization data is input from the first extension interface terminal group and the input initialization data is output from the second extension interface terminal group, or a state that initialization data is input from the second extension interface terminal group and the input initialization data is output from the first extension interface terminal group, according to the state of the second mode terminal in the second initializing operation.

### 2. Details of Embodiments

The embodiments will be described in more detail.

<<Liquid Crystal Display Panel>>

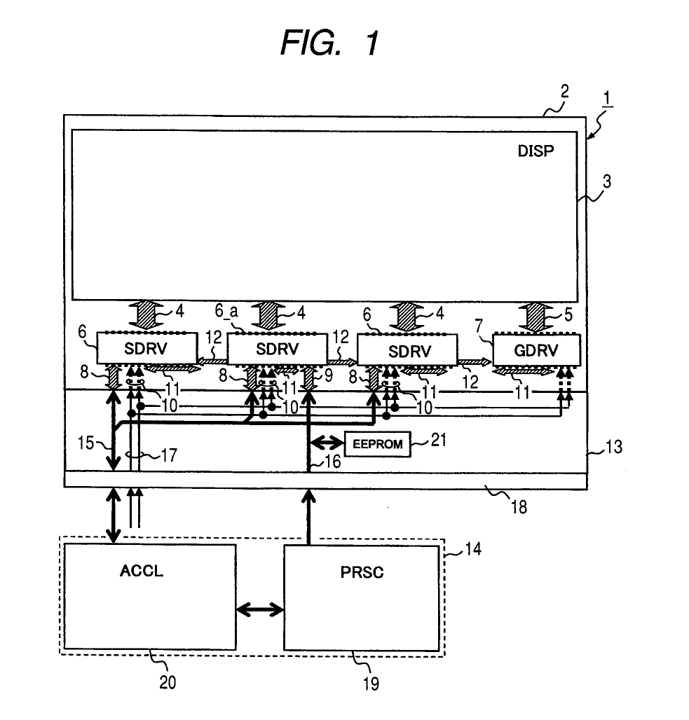

FIG. 1 illustrates a schematic configuration of a liquid crystal display panel. In a liquid crystal display panel 1 shown in FIG. 1, an active matrix liquid crystal display (DISP) 3 including liquid crystal, switching transistors, and the like is formed in a panel substrate 2 made of glass. A liquid crystal display 3 has many signal electrodes and scanning electrodes arranged to cross each other, and switching transistors are formed at the intersection points. The gate electrodes of the switching transistors are coupled to corresponding scanning electrodes, and the source electrodes, for example, are coupled to corresponding signal electrodes. The signal electrodes and the scanning electrodes are extended to marginal portions of the panel substrate 2 by, for example, ITO wiring patterns. The ITO (Indium Tin Oxide) wiring patterns are compound wiring patterns in which, for example, tin of a few percent is added to indium oxide, are pervious to visible light, and have relatively high resistances as compared with metal wirings of aluminum or the like. The reference numeral 4 denotes signal electrode wiring patterns made of ITO, and the reference numeral 5 denotes scanning electrode wiring patterns made of ITO.

The reference numeral 6 denotes source drivers (SDRVs) for driving the signal electrodes, and the reference numeral 7 denotes a gate driver (GDRV) for driving the scanning electrodes. Each of the drivers 6 and 7 is a semiconductor integrated circuit. The source drivers 6 and the gate driver 7 are mounted over corresponding ITO wiring patterns by a chip-on-glass (COG) technique. For the mounting, a technique of coupling bump electrodes which are external terminals of the source drivers 6 and gate driver 7 to corresponding ITO wiring patterns using anisotropic conductive films (ACFs) is used. The signal electrode driving external terminals of the source drivers 6 are coupled to the signal electrode wiring patterns 4, and the scanning electrode driving external terminals of the gate driver 7 are coupled to the scanning electrode wiring pattern 5. Other external terminals of the source drivers 6 and gate driver 7 are coupled to ITO wiring patterns 8, 9, 10, 11, and 12. The ITO wiring patterns 8, 9, and 10 are patterns for external interface, and the ITO wiring patterns 11 and 12 are patterns used for coupling between predetermined external terminals of the source drivers 6 and gate driver 7.

The reference numeral 13 denotes a flexible substrate (FPC substrate) coupling a host system 14 to the liquid crystal display panel 1. The flexible substrate 13 has metal wiring patterns 15, 16, and 17 made of copper or the like. A marginal portion of the flexible substrate 13 is fixed to an edge portion of the panel substrate 2 by ACFs so that ends of the metal wiring patterns 15, 16, and 17 electrically communicate with the ITO wiring patterns 8, 9, and 10. Connectors 18 are provided on the other ends of the metal wiring patterns 15, 16, and 17, and are coupled to a host processor (PRCS) 19 and an accelerator (ACCL) 20 for display control. A serial peripheral interface (SPI)-based serial EEPROM 21 is coupled to an intermediate point of the metal wiring pattern 16. The host processor 19 performs initialization, mode setting, or the like for the liquid crystal display panel 1. The accelerator 20 is a specialized processor for drawing control and display control of display data according to an instruction from the host processor 19.

Display data is supplied from the accelerator 20 to the metal wiring pattern 15. One ends of the ITO wiring patterns (first compound wiring patterns) 8 are mutually coupled to the metal wiring pattern 15, and the other ends of the ITO wiring patterns 8 are coupled to the display data input terminals of the source drivers 6, respectively. System interface information including initialization data of the drivers 6 and 7 is supplied from the host processor 19 to the metal wiring pattern 16. The metal wiring pattern 16 is coupled to one end of the ITO wiring pattern (second compound wiring pattern) 9, and the other end of the ITO wiring pattern 9 is coupled to an undermentioned system interface terminal of predetermined one source driver 6_{—}a. The ITO wiring patterns 12 (third compound wiring patterns) couple the source drivers 6 and the gate driver 7 in series, and system interface information received by the one first driver LSI 6_{—}a is supplied to the other source drivers 6 and the gate driver 7 in series through the ITO wiring patterns 12.

<<Source Driver LSI>>

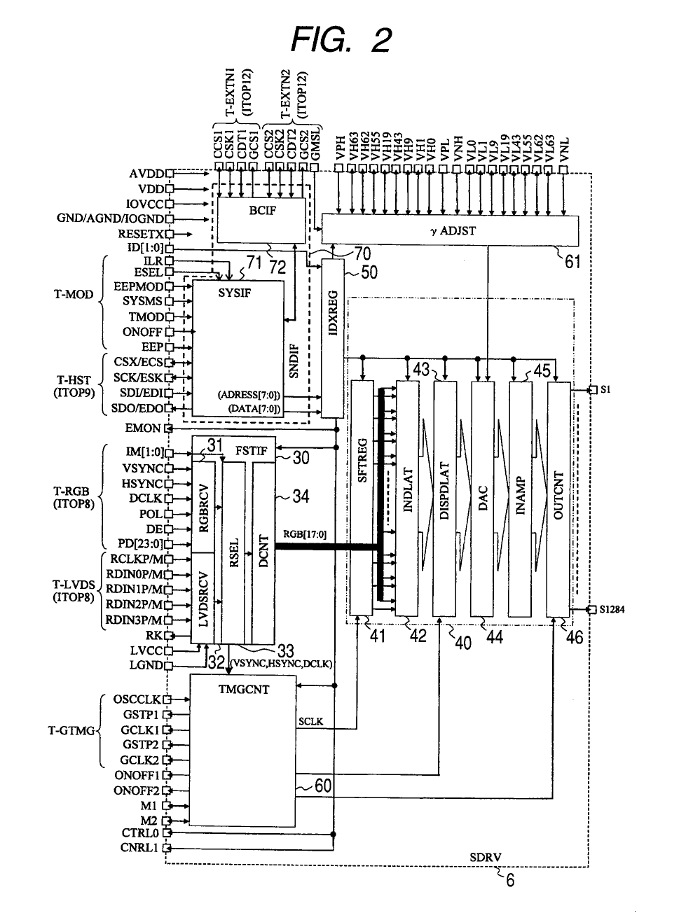

FIG. 2 illustrates the configuration of a source driver 6. The source driver 6 is formed on a semiconductor substrate by, for example, a complementary MOS integrated circuit manufacturing technique, and has a first external interface circuit (FSTIF) 30, a drive circuit 40, an index register (IDXREG) 50 as a storage circuit, control circuits 60 and 61, and a second external interface circuit (SNDIF) 70.

The first external interface circuit 30 is a circuit for receiving display data. The first external interface circuit 30 includes an RGB receiver (RGBRCV) 31 and a low voltage differential signaling (LVDS) receiver (LVDSRCV) 32 realizing a high-speed differential input interface as a display data input interface circuit, and converts data selected by a selector (RSEL) 33 to parallel data with a data control circuit (DCNT) 34 and supplies it to the driver circuit 40. The RGB receiver 31 is coupled to an RGB interface terminal group T-RGB, and the LVDS receiver 32 is coupled to an LVDS interface terminal group T-LVDS. PD[23:0] is an RGB data input terminal. A differential clock input terminal RCLKP/M and differential data input terminals RDIN0P/M to RDIN3P/M of four bits are shown as an example of external terminals for an LVDS interface. The RGB interface terminal group (T-RGB) and the LVDS interface terminal group T-LVDS are coupled to the ITO wiring pattern (ITOP) 8 described above.

The drive circuit 40 outputs drive signals from drive terminals S1 to S1284 based on data (RGB[17:0]) supplied from the first external interface circuit. The drive circuit 40 has a shift register (SFTREG) 41, an input data latch (INDLAT) 42, a display data latch (DISPDLAT) 43, a D/A converter (DAC) 44, an input amplifier (INAMP) 45, and an output control circuit (OUTCNT) 46.

The index register 50 is constituted by, for example, a SRAM and the like, and holds initialization data of the source driver 6. For example, the initialization data is display size data, γ correction data, and the like. Driving can be optimized for the size and display characteristic of a liquid crystal panel to be driven.

The control circuit 60 is a timing controller (TMGCNT) which controls the operation of outputting a drive signal of the drive circuit 40 and the operation timing of it. The control circuit 61 is a γ correction circuit (γADJST) which performs γ correction based on the initialization data held by the index register 50.

The second external interface circuit 70 has a system interface circuit (SYSIF) 71 and a between-chip input/output circuit (BCIF) 72.

The system interface circuit 71 has a system interface terminal group T-HST and a mode terminal group T-MOD. The between-chip input/output circuit 72 has a pair of extension interface terminal groups T-EXTN1 and T-EXTN2. In the configuration of FIG. 1, the system interface terminal group T-HST of one of the cascaded source driver LSIs is coupled to the ITO wiring pattern 9. The system interface terminal groups T-HST of the other of the source driver LSIs and part of the mode terminal groups T-MOD of the source drivers are coupled to VCCDUM or GNDDUM through an ITO wiring pattern 11 for level fixation. The extension interface terminal groups T-EXTN1 and T-EXTN2 are coupled to the ITO wiring patterns 12.

The system interface circuit 71 controls writing of initialization data to the index register 50 based on system interface information received from the system interface terminal group T-HST or one of the extension interface terminal groups T-EXTN1 and T-EXTN2. ADRESS[7:0] is a write address, while DATA[7:0] is a write data. For example, only when the higher-order 8 bits (ADRESS[7:0]) of 16 bit data (ADRESS[7:0], DATA[7:0]) input to the system interface circuit 71 matches the address of the index register (IDXREG) 50, the system interface circuit 71 stores the initialization data (DATA[7:0]) of the lower-order 8 bits into the index register 50 at the corresponding address.

The initializing operation of the system interface circuit 71 is a first initializing operation or a second initializing operation. The first initializing operation is an operation of writing initialization data included in system interface information input from the system interface terminal group T-HST into the index register 50 and outputting the system interface information from both sides of the source driver 6 in parallel through the extension interface terminal groups T-EXTN1 and T-EXTN2 of the between-chip input/output circuit 72. The second initializing operation is an operation of writing initialization data included in system interface information input from the outside of the source driver 6 to one of the extension interface terminal groups T-EXTN1 and T-EXTN2 into the index register 50 and outputting the system interface information from the other of the extension interface terminal groups T-EXTN1 and T-EXTN2 to the outside of the source driver 6. In FIG. 2, one pair of the extension interface terminal groups T-EXTN1 and T-EXTN2 are arranged adjacent to each other. However, the external terminal layout shown in FIG. 2 is different from the actual terminal layout. One pair of the extension interface terminal groups T-EXTN1 and T-EXTN2 are arranged at both ends of the bump electrode array of the source driver 6 with a distance between them.

<<Operation Mode of Source Driver LSI>>

The system interface circuit 71 has a first mode terminal SYSMS, a second mode terminal ILR, a third mode terminal ESEL, and a fourth mode terminal EEP.

The system interface circuit 71 selects the first initializing operation when the logical value of the first mode terminal SYSMS is “0”, and selects the second initializing operation when the logical value of the first mode terminal SYSMS is “1”. A source driver 6 which has selected the first initialization operation may be placed to perform a master operation as a host interface in a plurality of cascaded source drivers, while a source driver which has selected the second initializing operation may be placed to perform a slave operation.

A source driver 6 which has selected the first initializing operation outputs system interface information from both of the pair of extension interface terminal groups T-EXTN1 and T-EXTN2 in parallel. For this reason, a source driver 6 which has selected the first initializing operation is able to capture initialization data and supply it to the downstream as a base point at either of an end or an intermediate point of a cascade connection path. The formation of outputting system interface information from the extension interface terminal groups may be a formation of outputting it in both, one, or the other of the directions selected by a mode signal in addition to being fixed to a formation of outputting it in both of the directions described above. In this case, mode terminals for two bits must be added. Thus, the above configuration is the best in reducing the number of the external terminals.

When the logical value of the second mode terminal ILR is “0 ”, for example, an operation is selected by which system interface information is input to the extension interface terminal group T-EXTN1 on the left side of the source driver 6, and is output from the extension interface terminal group T-EXTN2 on the right side of the source driver 6. In contrast, when the logical value of the second mode terminal ILR is “1”, an operation is selected by which system interface information is output from the extension interface terminal group T-EXTN1 on the left side of the source driver 6, and is input to the extension interface terminal group T-EXTN2 on the right side of the source driver 6. Assignment of input and output to the pair of extension interface terminal groups T-EXTN1 and T-EXTN2 may be switched. The cascaded source drivers 6 are able to easily correspond to the direction of system interface information transmitted to them. Setting of the second mode terminal ILR becomes effective only when a slave operation has been selected with the first mode terminal SYSMS.

The system interface circuit 71 is able to select an SPI-based serial input interface function or an SPI-based EEPROM access interface function as an interface mode of the system interface information input from the system interface terminal group T-HST. For example, the system interface terminal group T-HST includes a chip-selection terminal CSX/ECS, a data input terminal SDI/EDI, a data output terminal SDO/EDO, and a clock terminal SCK/ESK for defining the timing of capturing data from the data input terminal. CSX, SDI, SDO, and SCK refer to terminal names in the SPI-based serial input interface function, and ECS, EDI, EDO, and ESK refer to terminal names in the SPI-based EEPROM interface function.

When the logical value of the third mode terminal ESEL is “0”, the SPI-based serial input interface function is selected. At that time, when a master operation has been selected with the mode terminal SYSMS, the system interface circuit 71 directly receives system interface information through the serial interface from the processor 19. On the other hand, when a slave operation has been selected with the mode terminal SYSMS, the system interface circuit 71 performs initialization data writing and the like regarding system interface information received from the between-chip interface circuit 72 as system interface information received through the serial interface from the processor 19. Furthermore, when the logical value of the third mode terminal ESEL is “1”, the SPI-based EEPROM access interface function is selected. At that time, when a master operation has been selected with the mode terminal SYSMS, the system interface circuit 71 performs direct read access of the EEPROM through the serial interface to read system interface information. On the other hand, when a slave operation has been selected with the mode terminal SYSMS, the system interface circuit 71 performs initialization data writing and the like regarding system interface information received from the between-chip interface circuit 72 as system interface information read from the EEPROM.

The system interface circuit 71 selects EEPROM operation with the fourth mode terminal EEP when it has selected the EEPROM interface function. When the logical value of the fourth mode terminal EEP is “0”, the system interface circuit 71 automatically starts the operation of reading system interface information from the EEPROM. The start of the operation is not particularly limited, but is synchronized with a signal from the ACCL 20 after a reset by an external reset signal RESETX is released. When the logical value of the fourth mode terminal is set to “1”, the system interface circuit 71 makes the system interface terminal group T-HST high impedance to make the interface function impossible. When system interface information is written into the serial EEPROM 21, the system interface circuit 71 selects the operation of making the interface function by the system interface terminal T-HST impossible. For this reason, a malfunction that the system interface circuit 71 directly captures write access information to the serial EEPROM 21 can be prevented. Such writing operation is needed when system interface terminals of a liquid crystal display panel are coupled to a device such as a checker to adjust or tune the initialization data and write it into the serial EEPROM during the manufacturing or assembling stage. Thus, after the adjusted or tuned initialization data has been written into the serial EEPROM 21, the logical value of the mode terminal EEP may be pulled down to “0” by the host system.

<<Extension Interface Terminal>>

The first extension interface terminal group T-EXTN1 includes a first chip-selection signal input/output terminal CCS1 used for input/output of a chip selection signal, a first data input/output terminal CDT1 used for input/output of initialization data, a first clock-signal input/output terminal CSK1 used for input/output of a clock signal, and a first chip-selection signal output terminal GCS1 used for output of a chip selection signal. The second extension interface terminal group T-EXTN2 includes a second chip-selection signal input/output terminal CCS2 used for input/output of a chip selection signal, a second data input/output terminal CDT2 used for input/output of initialization data, a second clock-signal input/output terminal CSK2 used for input/output of a clock signal, and a second chip-selection signal output terminal GCS2 used for output of a chip selection signal. The first and second chip-selection signal input/output terminals CCS1 and CCS2 are used for transmission of a chip selection signal between the cascaded semiconductor integrated circuits. The first and second chip-selection signal output terminals GCS1 and GCS2 are used for output of a chip selection signal to the gate driver LSI. When the logical value of the second mode terminal ILR is “0”, the first chip-selection signal input/output terminal CCS1, the first data input/output terminal CDT1, and the first clock-signal input/output terminal CSK1 are used as signal input terminals, the first chip-selection signal output terminal GCS1 is used as a fixed-level output terminal, and the second chip-selection signal input/output terminal CCS2, the second data input/output terminal CDT2, the second clock-signal input/output terminal CSK2, and the second chip-selection signal output terminal GCS2 are used as signal output terminals. When the logical value of the second mode terminal is “1”, the second chip-selection signal input/output terminal CCS2, the second data input/output terminal CDT2, and the second clock-signal input/output terminal CSK2 are used as signal input terminals, the second chip-selection signal output terminal GCS2 is used as a fixed-level output terminal, and the first chip-selection signal input/output terminal CCS1, the first data input/output terminal CDT1, the first clock-signal input/output terminal CSK1, and the first chip-selection signal output terminal GCS1 are used as signal output terminals. If signal output from the second chip-selection signal output terminals GCS1 and GCS2 of a source driver LSI other than the end source driver LSIs of cascaded source driver LSIs is allowed, a signal transmitted to the ITO wiring pattern 8, 9, or 12 may be influenced by a noise caused by the signal output, so that unnecessary signal output from the second chip-selection signal output terminals CCS1 and CCS2 is inhibited. Even if a master operation is selected for a source driver LSI at an end of cascaded source driver LSIs, signal output from both of the extension interface terminal groups T-EXTN1 and T-EXTN2 of the source driver LSI is allowed, because one of the extension interface terminal groups, unnecessary signal output from which is performed, is not placed at any position other than the end positions of the source driver LSIs.

The aforementioned timing controller 60 has timing control terminals T-GTMG for the gate driver 7. The timing control terminals T-GTMG include gate start pulse output terminals GSTP1 and GSTP2 and gate clock signal output terminals GCLK1 and GCLK2. A gate start pulse and a gate clock signal are timing signals synchronizing with the drive timing of the drive circuit 40. The former is a gate-scan start signal, and the latter is a gate-scan clock signal. The output terminals GSTP1 and GCLK1 are first timing output terminals arranged on the left side of the external terminal array of the source driver 6, and the output terminals GSTP2 and GCLK2 are second timing output terminals arranged on the right side of the external terminal array of the source driver 6. The timing controller 60 is able to select a state of outputting the timing signals from the first timing output terminals GSTP1 and GCLK1, a state of outputting the timing signals from the second timing output terminals GSTP2 and GCLK2, or a state of not outputting the timing signals from any of the first timing output terminals GSTP1 and GCLK1 and the second timing output terminals GSTP2 and GCLK2 according to predetermined initialization data stored in the storage circuit. According to the example of FIG. 1, only one source driver at the lower downstream of the cascaded source drivers 6 is able to output a timing signal to the gate driver 7, so that it becomes possible to prevent a noise caused by unnecessary output of a timing signal of the other of the source drivers. It is not shown in the figure but needless to say that the noise can be prevented also in the case that a gate driver 7 is connected to each of the source drivers 6 at both ends of cascaded source drivers 6.

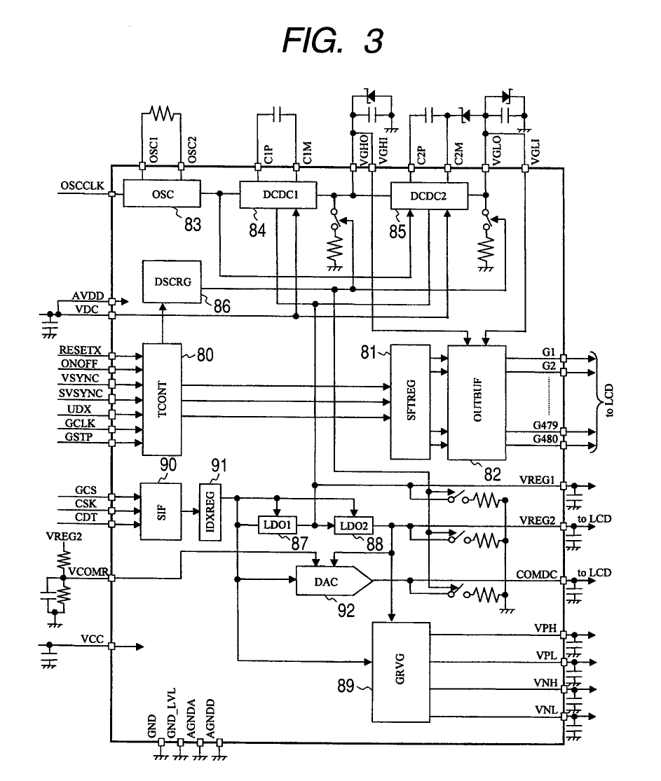

FIG. 3 illustrates the configuration of the gate driver 7. The control circuit (TCONT) 80 performs the overall control of the gate driver 7. A gate start pulse and a gate clock signal output from the output terminals GSTP1 and GCLK1 (GSTP2 and GCLK2) of the source driver 6 are input to the control circuit 80 through the input terminals GSTP and GCLK. The shift register (SFTREG) 81 generates a scan signal for selecting the gate electrodes of the liquid crystal display 3 in order. The output circuit (OUTBUF) 82 level-converts a VCC-GND signal which is an output signal of the shift register 81 to a VGH-VGL signal to output it to the gate output terminals G1 to G480. To the gate output terminals G1 to G480, corresponding gate electrode wirings are connected. The oscillating circuit (OSC) 83 is a CR oscillating circuit constituted by an external resistor and a capacitor in the chip, and generates an operating clock for the boosting circuit (DCDC1) 84 and boosting circuit (DCDC2) 85. The boosting circuits 84 and 85 are charge pump type boosting circuits. The boosting circuit 84 boosts VDC by two times to obtain a voltage VGH with a limiter circuit, and the boosting circuit 85 makes VDC negative to obtain a voltage VGL with a limiter circuit. The discharge control circuit (DSCRG) 86 controls switches coupled to the output terminals of the boosting circuits 84 and 85, the constant voltage source (LDO1) 87, and the constant voltage source (LDO2) 88 to discharge the electric charge in the external capacitors to the ground GND. The constant voltage sources 87 and 88 generate reference voltages VREG1 and VREG2 and supply them to circuits in the chip. VREG1 is a reference voltage. VREG2 is used as a reference voltage for γ correction of the source driver, and the like. The γ reference voltage generating circuit (GRVG) 89 generates a γ reference voltage of the source driver, two reference voltages for the positive electrode VPH and VPL, and two reference voltages for the negative electrode VNH and VNL using VREG2 supplied from the boosting circuit 88 as a reference voltage, and supplies them to circuits in the chip. The serial interface circuit (SIF) 90 is a serial interface circuit to which initialization data is supplied from the source driver 6. The serial interface circuit 90 stores, for example, eight lower-order bits into the index register (IDXREG) 91 only when eight higher-order bits match the address of the index register 91 every input 16-bit data. The digital-to-analog converting circuit (DAC) 92 generates a voltage COMDC.

<<Formation of Coupling by ITO Wiring Pattern>>

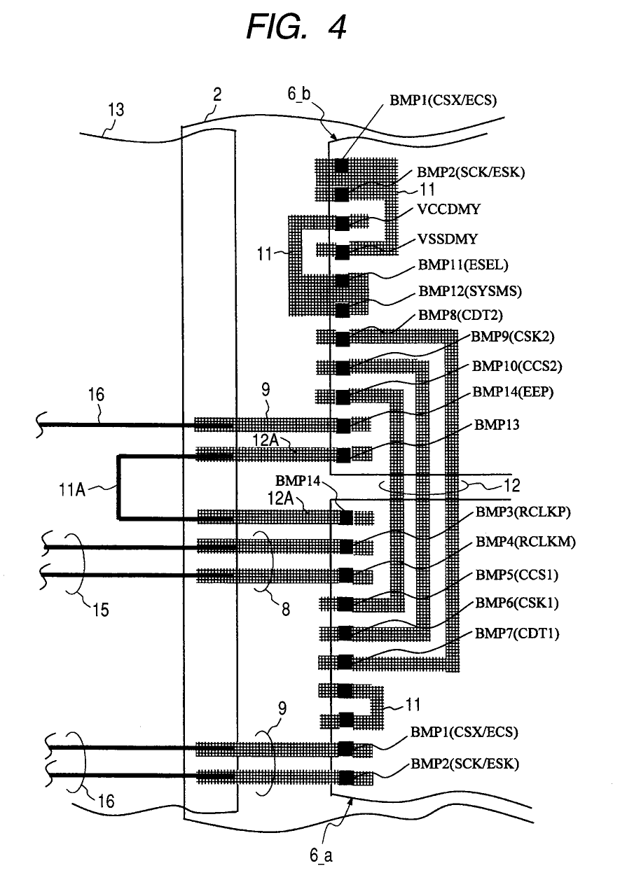

FIG. 4 illustrates the formation of coupling by ITO wiring patterns. The panel substrate 2 and the flexible substrate 13 partially overlap each other (hatched portion), and ITO wiring patterns are fixed to the overlap portion through ACF. In FIG. 4, part of each of two source drivers 6_{—}a and 6_{—}b is shown. ITO wiring patterns 9 which are coupled to bump electrodes of the source driver 6_{—}a are coupled to metal wirings 16 so that system interface information is supplied to the source driver 6_{—}a. The system interface information input to the source driver 6_{—}a is supplied from the bump electrodes BMP5 to BMP7 of the source driver 6_{—}a to the bump electrodes BMP8 to BMP10 of the source driver 6_{—}b through the ITO wiring patterns 12. The bump electrodes BMP1 and BMP2 of the source driver 6_{—}b corresponding to the bump electrodes BMP1 and BMP2 of the source driver 6_{—}a are coupled to an ITO wiring pattern 11 and then coupled to a ground dummy bump VSSDMY to which a ground potential is given from the inside of the source driver 6_{—}b to suppress the floating of the input circuit. Bump electrodes BMP11 and BMP12 as mode terminals of the source driver 6_{—}b are coupled to, for example, a power dummy bump VDDDMY to which an external power potential is given from the inside of the source driver 6_{—}b to set a mode. A fourth mode terminal EEP is not coupled to the power dummy bump VDDDMY or the ground dummy bump VSSDMY, and the level of the fourth mode terminal EEP is decided using the ITO wiring pattern 9 and the metal wiring pattern 16 by the host device 14. Part of ITO wiring patterns 12 for connection between the source drivers 6_{—}a and 6_{—}b can be replaced with an ITO wiring pattern 12A and a metal wiring pattern 11A. Furthermore, In FIG. 4, the ITO wiring patterns 12 are not extended so as to pass through under the cascaded source drives 6_{—}a, 6_{—}b, and 6_{—}c and are divided between one extension interface terminal group T-EXTN1 and the other extension interface terminal group T-EXTN2 of each of the source drivers. Thus, the impedance of the ITO wiring patterns 12 can be reduced.

<<Examples of Use of Source Drivers>>

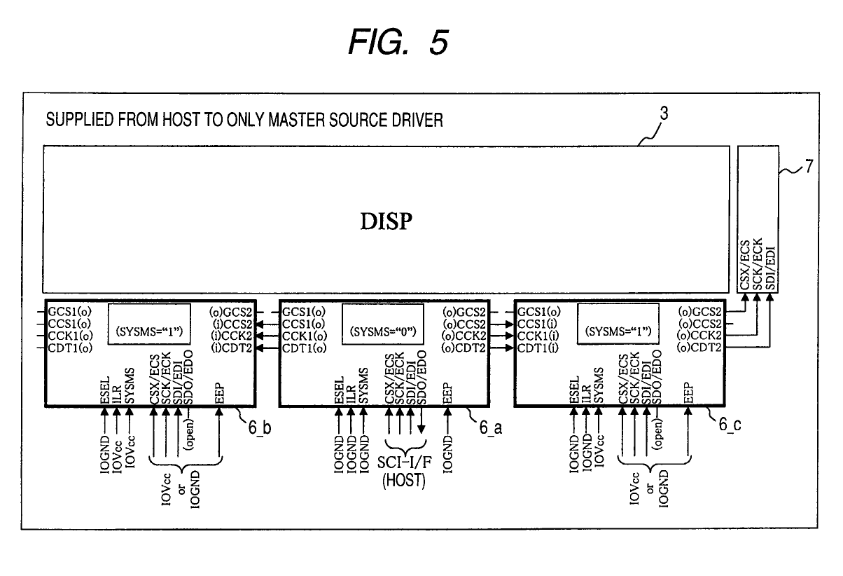

FIG. 5 shows an example of mode setting for source drivers in the case that only one master source driver is system-interfaced. FIG. 5 shows the mode setting state of cascaded three source drivers 6_{—}a, 6_{—}b, and 6_{—}c of a liquid crystal display panel which is configured so as to input system interface information to the center source driver 6_{—}a through an SPI-based serial interface. The source driver 6_{—}a selects a master operation by SYSMS=“0”, and the source drivers 6_{—}b and 6_{—}c select a slave operation by SYSMS=“1”. The mode terminals ESEL are coupled to IOGND to be set to “0”. The symbol (o) attached to a terminal name in the figure means that an output operation has been selected, and the symbol (i) attached to a terminal name in the figure means that an input operation has been selected. IOGND is a ground potential which is given by, for example, the aforementioned dummy ground pad VSSDMY, and IOVcc is an external power potential which is given by, for example, the aforementioned dummy power pad VCCDMY. The modes have been set using these potentials. It is not shown in the figures but is possible to couple a gate driver 7 to a source driver at an end opposite to an end shown in FIG. 5 of the cascaded source drivers or to each of source drivers at both ends of the cascaded source drivers.

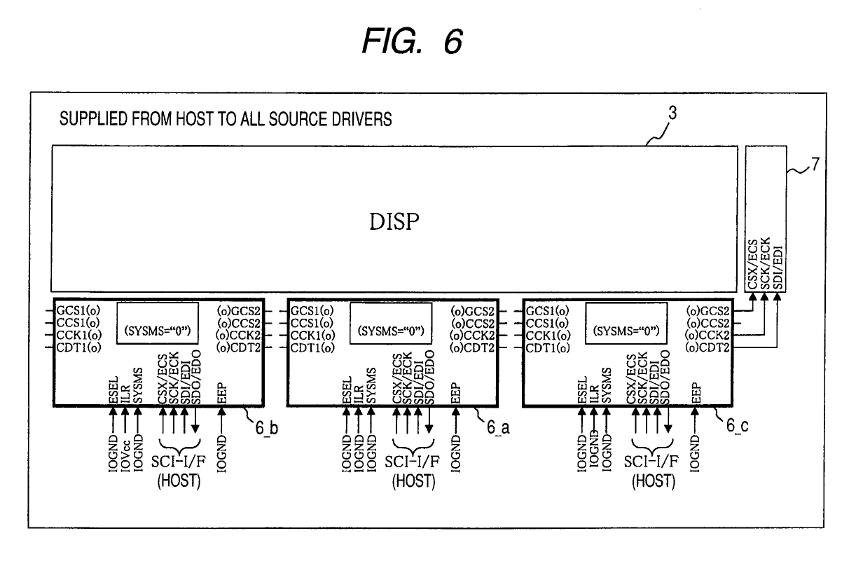

FIG. 6 shows an example of mode setting for source drivers in the case that all of the source drivers are allowed to perform a master operation to be system-interfaced. FIG. 6 shows the mode setting state of cascaded three source drivers 6_{—}a, 6_{—}b, and 6_{—}c of a liquid crystal display panel which is configured so as to input system interface information to each of the source drivers 6_{—}a, 6_{—}b, and 6_{—}c through an SPI-based serial interface. Each of the source drivers 6_{—}a, 6_{—}b, and 6_{—}c selects a master operation by SYSMS=“0”. The symbol (o) attached to a terminal name in the figure means that an output operation has been selected, and the symbol (i) attached to a terminal name in the figure means that an input operation has been selected. IOGND is a ground potential which is given by, for example, the aforementioned dummy ground pad VSSDMY, and IOVcc is an external power potential which is given by, for example, the aforementioned dummy power pad VCCDMY. The modes have been set using these potentials. It is not shown in the figures but is possible to couple the gate driver 7 to a source driver at an end opposite to an end shown in FIG. 5 of the cascaded source drivers or to each of source drivers at both ends of the cascaded source drivers.

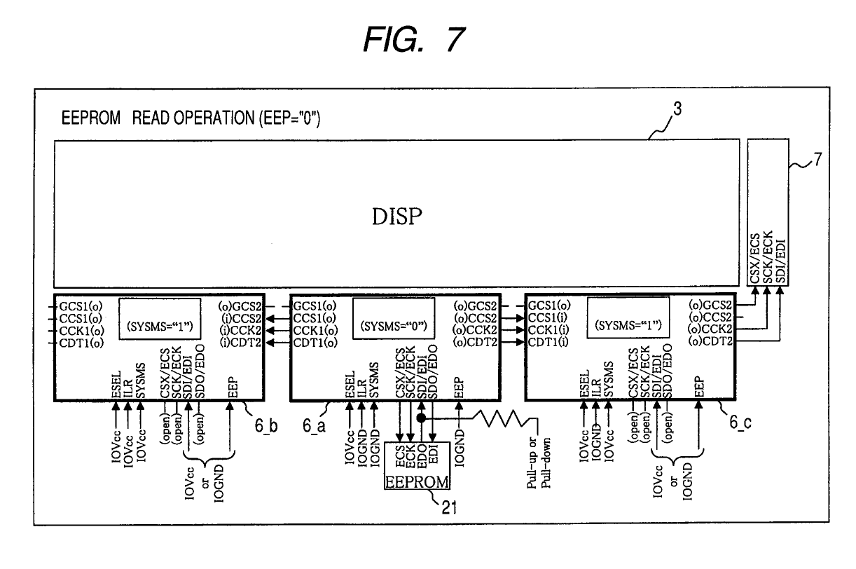

FIG. 7 shows an example of mode setting for source drivers in the case that one master source driver is only system-interfaced through an EEPROM. FIG. 7 shows the mode setting state of cascaded three source drivers 6_{—}a, 6_{—}b, and 6_{—}c of a liquid crystal display panel which is configured so as to input system interface information to the center source driver 6_{—}a through an SPI-based EEPROM access interface. The source driver 6_{—}a selects a master operation by SYSMS=“0”, and the source drivers 6_{—}b and 6_{—}c select a slave operation by SYSMS=“1”. The mode setting state is different from that in FIG. 5 in the setting states of the mode terminals ESEL. The mode terminals ESEL are coupled to IOVcc to be set to “1”. In this case, the mode terminals EEP are coupled to IOGND to be set to “0”, and the system interface circuit 71 reads initialization data by read access of the EEPROM 21 in synchronization with a signal from the ACCL20 after a cancel of a reset instruction, for example, and writes the read initialization data into the index register 50.

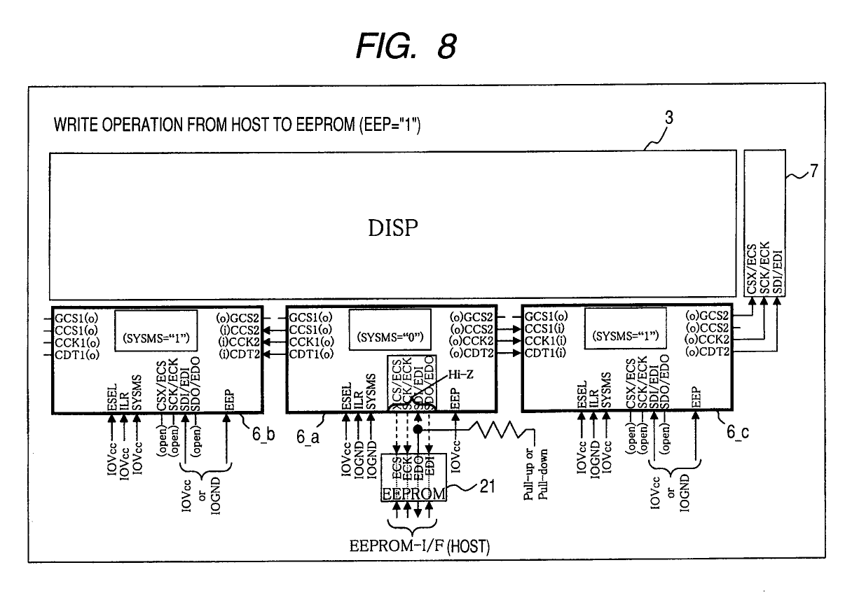

FIG. 8 shows a state that an EEPROM write mode has been set for one master source driver. The mode terminal EEP of the source driver 6_{—}a is coupled to IOVcc to be set to “1”. In this case, the system interface terminals T-HST of the system interface circuit 71 are all put into a high impedance state (HiZ). For this reason, system interface information is written into the EEPROM 21 by the host processor. When the host interface information written into the EEPROM 21 is read, the mode terminal EEP must be changed to “0”. Writing the host interface information into the EEPROM 21 is performed, for example, at tuning with a checker or the like during the manufacturing stage of the liquid crystal display panel. Thus, when the completed liquid crystal display panel is built in equipment and coupled to a host device 14, the fourth mode terminal EEP is fixed to a GND level by a logical value “0” from the host system 14.

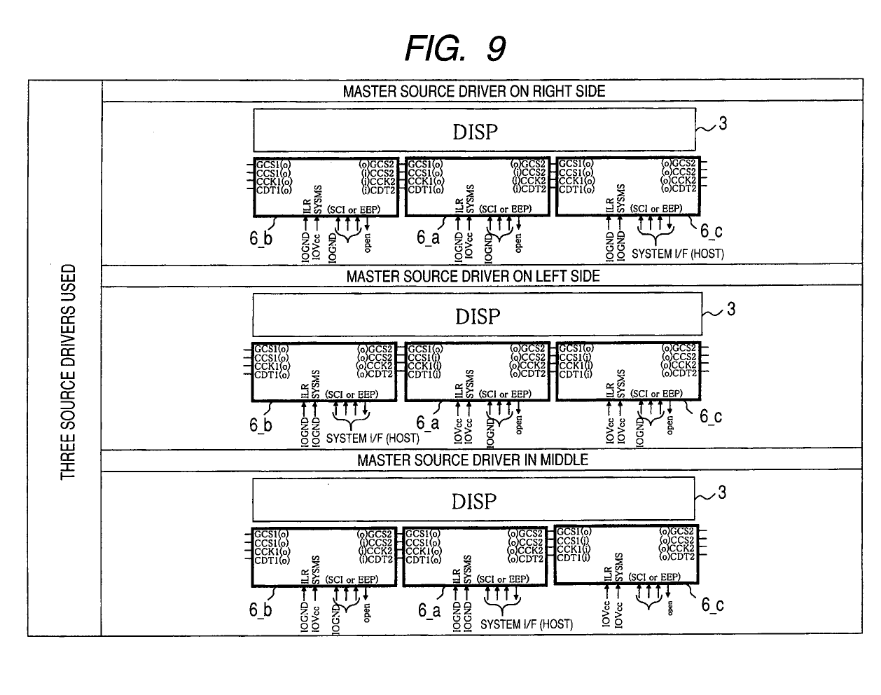

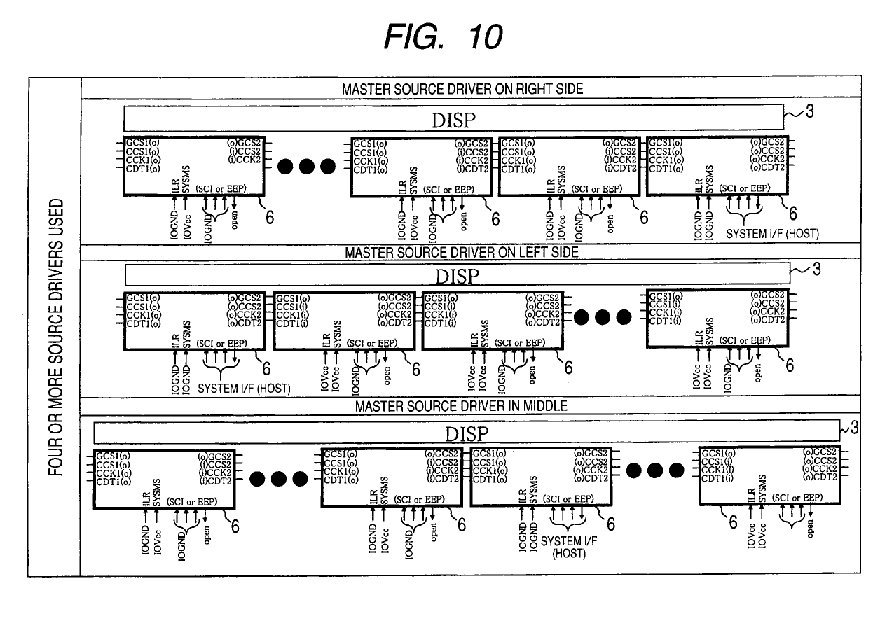

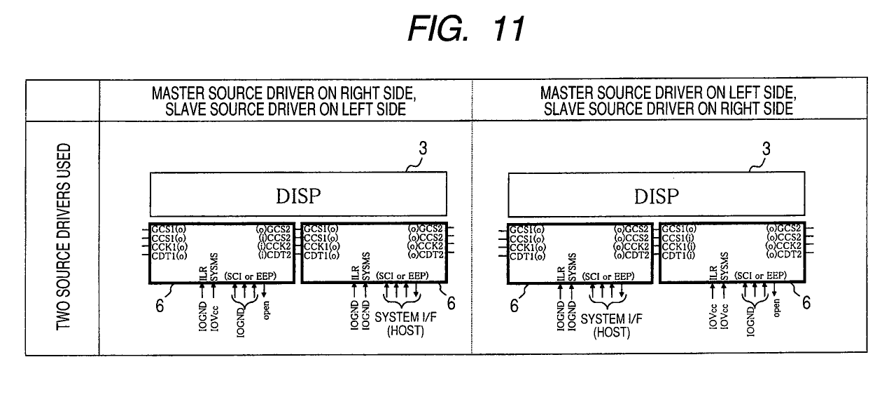

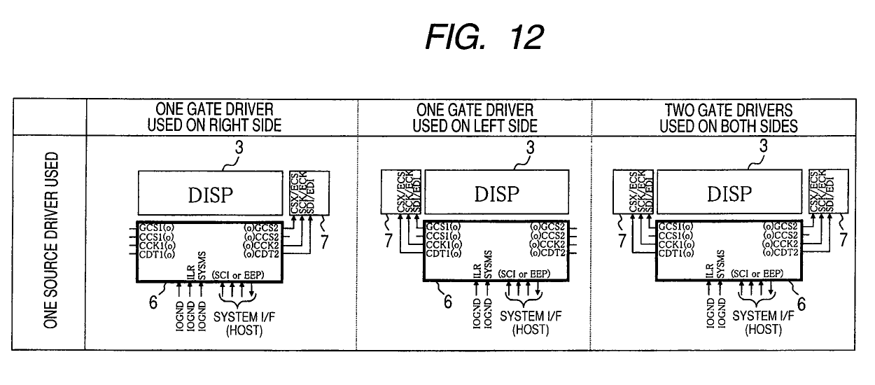

In the examples in which three source drivers 6_{—}a, 6_{—}b, and 6_{—}c are cascaded, a source driver for which a master operation may be set is not limited to the center source driver, and as shown in FIG. 9, a master operation may be set for either of the left source driver 6_{—}b or the right source driver 6_{—}c. Furthermore, the number of cascaded source drivers is not limited to three, and four or more source drivers may be cascaded as appropriate as shown in FIG. 10. Also in this case, as a matter of course, a source driver for which a master operation is set can be freely decided by the logical values of the mode terminals SYSMS. Furthermore, it is also possible to use cascaded two source drivers 6 as illustrated in FIG. 11. In addition, it is also possible to use one source driver 6 to constitute a liquid crystal panel as illustrated in FIG. 12. It is needless to say that also in the case that one source driver 6 is used, a gate driver 7 may be arranged on either the right side or left side of the source driver 6 or on each of both sides of the source driver 6. In FIGS. 9 to 11, it is omitted to show gate drivers.

According to the liquid crystal display panels described above, the following operations and effects will be obtained.

[1] When a first initializing operation has been selected for a source driver 6 to allow the source driver to perform a master initializing operation, the source driver is able to capture initialization data as a base point of a cascade connection path. Furthermore, when a second initializing operation has been selected for a source driver to allow the source driver 6 to operate a slave initializing operation, the source driver is able to capture initialization data supplied from the upstream of a cascade connection path.

[2] Setting of a master initializing operation or a slave initializing for a source driver can be easily selected with a first mode terminal (SYSMS).

[3] When a master initializing operation has been set for a source driver, the system interface circuit 71 of the source driver outputs system interface information from both of the extension interface terminal groups T-EXTN1 and T-EXTN2, so that the source driver is able to capture initialization data and supply it to the downstream of a cascade connection path as a base point at either of an end or any intermediate point of the cascade connection path. An output formation of outputting system interface information from the extension interface terminal groups T-EXTN1 and T-EXTN2 may be fixed to an output formation of outputting system interface information from both of them described above. However, an output formation of outputting system interface information from both, one, or the other one of them may be selected according to a mode signal, which requires mode terminals for two bits.

[4] With second mode terminals (ILR), cascaded source drivers 6 are able to easily correspond to any direction of system interface information transmitted to the source drivers 6.

[5] With a third mode terminal (ESEL), a source driver is able to easily select an SPI-based serial input interface function or an SPI-based memory access interface function as an interface mode of system interface information. Thus, the source driver 6 is able to directly receive system interface information through a serial interface from a host system, with an SPI which requires little number of interface terminals, and is able to capture system interface information previously written into a serial EEPROM 21 by a host system by memory access.

[6] When writing of system interface information into the EEPROM 21 is selected with the fourth mode terminal (EEP), the system interface terminal groups are made high impedance, so that a malfunction that the system interface circuit 71 directly captures write access information to the serial EEPROM 21 when system interface information is previously written into the serial EEPROM 21 can be prevented.

[7] A state of making it impossible that a source driver 6 outputs a gate timing signal from one or both of the right and left terminals of the source driver can be selected according to initialization data. For this reason, only one source driver at the lower downstream of cascaded source drivers is able to output a timing signal to a gate driver 7, so that it is possible to suppress a noise caused by unnecessary output of a timing signal of the other of the source drivers 6.

[8] Display data is supplied to each of source drivers 6 in parallel through ITO wiring patterns 8, so that a high-speed display operation is possible. Supply of initialization data for a initializing operation to which a high speed is not required as compared with display operation is performed using ITO wiring patterns 12 for cascade connection between source drivers 6 and between a source driver and a gate driver 7, so that one of cascaded source drivers 6 is made a base point for supply of initialization data to them and initialization data may be supplied to the one source driver 6 from the host system using the ITO wiring pattern 9. Thus, the number of connection points between the metal wiring pattern 16 over the flexible wiring substrate 13 and the ITO wiring patterns 9 over the panel substrate 2 for supply of initialization data can be reduced. If the number of connection points is reduced, it becomes easy to increase the widths of the ITO wiring patterns in the connection portions and it becomes easy to reduce the resistance of the ITO wiring patterns. Furthermore, one of cascaded source drivers may be made a base point of supply of initialization data for them, so that flexibility in the formation of coupling between the panel substrate 2 and the host system and flexibility in the wiring structure of the flexible substrate 13 can be increased.

[9] ITO wiring patterns coupled to each of extension interface terminal groups T-EXTN1 and extension interface terminal groups T-EXTN2 of source drivers 6 are divided between the extension interface terminal group T-EXTN1 and the extension interface terminal group T-EXTN2 of each of the source drivers 6. Thus, the impedance of the ITO wiring patterns 12 can be reduced.

Up to this point, the present invention developed by the inventor has been concretely described based on the embodiments. However, it is needless to say that the present invention is not limited to the embodiments and various changes and modifications can be made without departing from the spirit and scope of the present invention.

For example, a compound wiring pattern pervious to visible light is not limited to an ITO (Indium Tin Oxide) wiring pattern. The panel substrate is made of glass or polyethylene terephthalate. For example, glass is used for a liquid crystal panel, and polyethylene terephthalate is used for an electronic paper. Concrete configurations of a source driver and a gate driver are not limited to ones in FIGS. 2 and 3. A liquid crystal panel can be applied to various kinds of electric equipment such as a TV receiver, a personal computer, a PDA, and a mobile phone.

Furthermore, the present invention is not limited to a display, and can be widely applied to an electronic circuit needing initialization and in particular to an electronic circuit in which an input path for processing data is different from an input path for initialization data. An LSI corresponding to a source driver is a control semiconductor integrated circuit.

What is claimed is:

1. A semiconductor integrated circuit comprising: a first external interface circuit for receiving processing data from the outside of the semiconductor integrated circuit; a processing circuit for processing the processing data supplied from the first external interface circuit; a storage circuit capable of holding initialization data; a control circuit controlling the operation of the processing circuit on the basis of the initialization data held by the storage circuit; and a second external interface circuit having a first interface terminal group and a pair of second interface terminal groups which are external terminals of the semiconductor integrated circuit, wherein the second external interface circuit is able to select a first initializing operation of writing initialization data included in interface information received from the first interface terminal group into the storage circuit and outputting the interface information from the second interface terminal groups to the outside of the semiconductor integrated circuit, or a second initializing operation of writing initialization data included in interface information received from one of the second interface terminal groups into the storage circuit and outputting the interface information from the other of the second interface terminal groups to the outside of the semiconductor integrated circuit.

2. The semiconductor integrated circuit according to claim 1, wherein the second external interface circuit has a first mode terminal which is an external terminal of the semiconductor integrated circuit, and selects the first initializing operation or the second initializing operation according to the state of the first mode terminal.

3. The semiconductor integrated circuit according to claim 2, wherein the second external interface circuit outputs the interface information from both of the pair of second interface terminal groups in the first initializing operation.

4. The semiconductor integrated circuit according to claim 3, wherein the second external interface circuit has a second mode terminal which is an external terminal of the semiconductor integrated circuit, and switches assignment of input and output to the pair of second interface terminal groups according to the state of the second mode terminal, the assignment allowing one of the second interface terminal groups to be used as an input terminal group for the interface information and allowing the other one thereof to be used as an output terminal group for the interface information in the second initializing operation.

5. A semiconductor integrated circuit comprising: a first external interface circuit for receiving drive data from the outside of the semiconductor integrated circuit; a drive circuit outputting a drive signal on the basis of the drive data supplied from the first external interface circuit; a storage circuit capable of holding initialization data; a control circuit controlling an output operation of the drive signal by the drive circuit on the basis of the initialization data held by the storage circuit; and a second external interface circuit having a first interface terminal group and a pair of second interface terminal groups which are external terminals of the semiconductor integrated circuit, wherein the second external interface circuit is able to select a first initializing operation of writing initialization data included in system interface information received from the first interface terminal group into the storage circuit and outputting the system interface information from the second interface terminal groups to the outside of the semiconductor integrated circuit, or a second initializing operation of writing initialization data included in system interface information input from the outside of the semiconductor integrated circuit to one of the second interface terminal groups into the storage circuit and outputting the system interface information from the other one of the second interface terminal groups to the outside of the semiconductor integrated circuit.

6. The semiconductor integrated circuit according to claim 5, wherein the second external interface circuit has a third mode terminal which is an external terminal of the semiconductor integrated circuit, and selects an SPI-based serial input interface function or an SPI-based memory access interface function, according to the state of the third mode terminal, as an interface mode for the system interface information.

7. The semiconductor integrated circuit according to claim 6, wherein the second external interface circuit has a chip-selection terminal, a data input terminal, a data output terminal, and a clock terminal for defining the timing of capturing data from the data input terminal.

8. The semiconductor integrated circuit according to claim 7, wherein the second external interface circuit has a fourth mode terminal which is an external terminal of the semiconductor integrated circuit, enables an SPI-based memory read operation when the fourth mode terminal is in a predetermined state, and puts the first interface terminal group into a high impedance state when the fourth mode terminal is in any other state.

9. The semiconductor integrated circuit according to claim 8, wherein the second external interface circuit has a first mode terminal which is an external terminal of the semiconductor integrated circuit, and selects the first initializing operation or the second initializing operation according to the state of the first mode terminal.

10. The semiconductor integrated circuit according to claim 9, wherein the second external interface circuit includes a first extension interface terminal group and a second extension interface terminal group as the pair of second interface terminal groups, and outputs system interface information from both of the first extension interface terminal group and the second extension interface terminal group in the first initializing operation.

11. The semiconductor integrated circuit according to claim 10, wherein: the second external interface circuit has a second mode terminal which is an external terminal of the semiconductor integrated circuit, and selects a state that system interface information is input from the first extension interface terminal group and the input system interface information is output from the second extension interface terminal group, or a state that system interface information is input from the second extension interface terminal group and the input system interface information is output from the first extension interface terminal group, according to the state of the second mode terminal, in the second initializing operation.

12. The semiconductor integrated circuit according to claim 11, wherein: the first extension interface terminal group includes: a first chip-selection signal input/output terminal used for input and output of a chip selection signal; a first data input/output terminal used for input and output of initialization data; a first clock-signal input/output terminal used for input and output of a clock signal; and a first chip-selection signal output terminal used for output of a chip selection signal; the second extension interface terminal group includes: a second chip-selection signal input/output terminal used for input and output of a chip selection signal; a second data input/output terminal used for input and output of initialization data; a second clock-signal input/output terminal used for input and output of a clock signal; and a second chip-selection signal output terminal used for output of a chip selection signal; when the second mode terminal is in a predetermined state, the first chip-selection signal input/output terminal, the first data input/output terminal, and the first clock-signal input/output terminal are used as signal input terminals, the first chip-selection signal output terminal is used as a fixed-level output terminal, and the second chip-selection signal input/output terminal, the second data input/output terminal, the second clock-signal input/output terminal, and the second clock-signal output terminal are used as signal output terminals; and when the second mode terminal is in any other state, the second chip-selection signal input/output terminal, the second data input/output terminal, and the second clock-signal input/output terminal are used as signal input terminals, the second chip-selection signal output terminal is used as a fixed-level output terminal, and the first chip-selection signal input/output terminal, the first data input/output terminal, the first clock-signal input/output terminal, and the first chip-selection signal output terminal are used as signal output terminals.

13. The semiconductor integrated circuit according to claim 12, wherein the control circuit has a first timing output terminal and a second timing output terminal which are used for output of a timing signal synchronizing with the drive timing of the drive circuit to the outside of the semiconductor integrated circuit, and is able to select any of a state of outputting the timing signal from the first timing output terminal, a state of outputting the timing signal from the second timing output terminal, and a state of not outputting the timing signal from any of the first timing output terminal and the second timing output terminal, according to predetermined initialization data stored in the storage circuit.

14. The semiconductor integrated circuit according to claim 13, wherein the storage circuit has a storage area for storing display size data and γ correction data as the initialization data.

15. A display device comprising: a plurality of first semiconductor integrated circuits driving a plurality of signal electrodes of an active matrix display; and a second semiconductor integrated circuit driving a plurality of scanning electrodes of the display, mounted in a panel substrate which has first to third compound wiring patterns pervious to visible light and in which the display is formed, wherein: the first semiconductor integrated circuits and the second semiconductor integrated circuit are allowed to couple to a host system through wirings of a flexible wiring substrate coupled to the first and second compound wiring patterns; one end of the first compound wiring pattern is coupled to a wiring over the flexible wiring substrate to which display data is supplied from the host system; the other end of the first compound wiring pattern is coupled to the respective first semiconductor integrated circuits in parallel; one end of the second compound wiring pattern is coupled to a wiring over the flexible wiring substrate to which system interface information including initialization data for display control is supplied from the host system; the other end of the second compound wiring pattern is coupled to predetermined one of the first semiconductor integrated circuits; the third compound wiring pattern couples the first semiconductor integrated circuits and the second semiconductor integrated circuit in series; and system interface information received by the predetermined one of the first semiconductor integrated circuits is supplied to the other of the first semiconductor integrated circuits and the second semiconductor integrated circuit in series through the third compound wiring pattern.

16. The display device according to claim 15, wherein the compound wiring patterns pervious to visible light are indium tin oxide (ITO) wiring patterns.

17. The display device according to claim 16, wherein the panel substrate is made of glass or polyethylene terephthalate.

18. The display device according to claim 15, wherein a nonvolatile memory into which initialization data for display control is allowed to be written is provided at an intermediate point of the wiring over the flexible wiring substrate to which system interface information including the initialization data for display control is supplied from the host system.

19. The display device according to claim 18, wherein each of the first semiconductor integrated circuits has an SPI-based serial input interface mode and an SPI-based memory access interface mode which can be selected as a host interface mode of receiving system interface information from the host system.

20. The display device according to claim 15, wherein: each of the first semiconductor integrated circuits includes: a first external interface circuit coupled to the first compound wiring pattern; a drive circuit driving the signal electrodes on the basis of processing data supplied from the first external interface circuit; a storage circuit capable of holding the initialization data; a control circuit controlling the operation of the drive circuit on the basis of the initialization data held by the storage circuit; and a second external interface circuit having a first interface terminal group and a pair of second interface terminal groups as external terminals of the first semiconductor integrated circuit; the second external interface circuit of the predetermined one of the first semiconductor integrated circuits selects a first initializing operation of writing initialization data included in system interface information input from the second compound wiring pattern to the first interface terminal group into the storage circuit and outputting the system interface information from the second interface terminal groups to the third compound wiring pattern;
and the second external interface circuits of the other of the first semiconductor integrated circuits select a second initializing operation of writing initialization data included in system interface information input from the third compound wiring pattern to one of the second interface terminal groups into the storage circuit and outputting the system interface information from the other of the second interface terminal groups to the third compound wiring pattern.

21. The display device according to claim 20, wherein each of the first semiconductor integrated circuits has a first mode terminal which is an external terminal, and the second external interface circuit selects the first initializing operation or the second initializing operation according to the state of the first mode terminal.

22. The display device according to claim 21, wherein: the second external interface circuit includes a first extension interface terminal group and a second extension interface terminal group as the pair of second interface terminal groups; and the first semiconductor integrated circuit which has selected the first initializing operation outputs the system interface information from the first extension interface terminal group and the second extension interface terminal group to the third compound wiring pattern.

23. The display device according to claim 22, wherein the third compound wiring pattern coupled to each of the first extension interface terminal group and second extension interface terminal group of one of the first semiconductor integrated circuits is divided between the first extension interface terminal group and the second extension interface terminal group.

24. The display device according to claim 22, wherein: each of the first semiconductor integrated circuits has a second mode terminal which is an external terminal; and each of the first semiconductor integrated circuits for which the second initializing operation has been selected selects a state that system interface information is input from the first extension interface terminal group and the input system interface information is output from the second extension interface terminal group, or a state that system interface information is input from the second extension interface terminal group and the input system interface information is output from the first extension interface terminal group, according to the state of the second mode terminal, in the second initializing operation.

25. A display device comprising a plurality of control semiconductor integrated circuits controlling an image display unit provided in a panel substrate which has first to third compound wiring patterns pervious to visible light and in which the image display unit is formed, the control semiconductor integrated circuits being allowed to couple to a host system through the compound wiring patterns, wherein: the first compound wiring pattern receives control data supplied from the host system and is coupled to the respective control semiconductor integrated circuits in parallel; the second compound wiring pattern receives system interface information including initialization data from the host system, and is coupled to predetermined one of the control semiconductor integrated circuits; the third compound wiring pattern couples the control semiconductor integrated circuits in series; and system interface information received by the predetermined one of the control semiconductor integrated circuits is supplied to the other of the control semiconductor integrated circuits in series through the third compound wiring pattern.

26. The display device according to claim 25, wherein the compound wiring patterns pervious to visible light are ITO wiring patterns.

27. The display device according to claim 26, wherein the panel substrate is made of glass or polyethylene terephthalate.

28. The display device according to claim 25, wherein: each of the control semiconductor integrated circuits includes: a first external interface circuit coupled to the first compound wiring pattern; a processing circuit for processing control data supplied from the first external interface circuit; a storage circuit capable of holding the initialization data; a control circuit controlling the operation of the processing circuit on the basis of the initialization data held by the storage circuit; and a second external interface circuit having a first interface terminal group and a pair of second interface terminal groups as external terminals of the control semiconductor integrated circuit; the second external interface circuit of the predetermined one of the control semiconductor integrated circuits selects a first initializing operation of writing initialization data included in system interface information input from the second compound wiring pattern to the first interface terminal group into the storage circuit and outputting the system interface information from the second interface terminal groups to the third compound wiring pattern, and the second external interface circuits of the other of the control semiconductor integrated circuits select a second initializing operation of writing initialization data included in system interface information input from the third compound wiring pattern to one of the second interface terminal groups into the storage circuit and outputting the system interface information from the other of the second interface terminal groups to the third compound wiring pattern.

29. The display device according to claim 28, wherein each of the control semiconductor integrated circuits has a first mode terminal which is an external terminal, and the second external interface circuit selects the first initializing operation or the second initializing operation according to the state of the first mode terminal.

30. The display device according to claim 29, wherein: the second external interface circuit includes a first extension interface terminal group and a second extension interface terminal group as the pair of second interface terminal groups; and the predetermined one of the control semiconductor integrated circuits which has selected the first initializing operation outputs the system interface information from both of the first extension interface terminal group and the second extension interface terminal group to the third compound wiring pattern.

31. The display device according to claim 30, wherein the third compound wiring pattern coupled to each of the first extension interface terminal group and second extension interface terminal group of one of the control semiconductor integrated circuits is divided between the first extension interface terminal group and the second extension interface terminal group.

32. The display device according to claim 30, wherein: each of the control semiconductor integrated circuits has a second mode terminal which is an external terminal; and each of the control semiconductor integrated circuits selects a state that system interface information is input from the first extension interface terminal group and the input system interface information is output from the second extension interface terminal group, or a state that system interface information is input from the second extension interface terminal group and the input system interface information is output from the first extension interface terminal group, according to the state of the second mode terminal, in the second initializing operation.

33. An electronic circuit comprising a plurality of control semiconductor integrated circuits provided in a substrate having first to third wiring patterns, the control semiconductor integrated circuits allowing initialization data and processing data to be supplied from a host system through the first to third wiring patterns, wherein: the first wiring pattern receives the processing data supplied from the host system and is coupled to the respective control semiconductor integrated circuits in parallel; the second wiring pattern receives the initialization data from the host system and is coupled to predetermined one of the control semiconductor integrated circuits; the third wiring pattern couples the control semiconductor integrated circuits in series; and the initialization data received by the predetermined one of the control semiconductor integrated circuits is supplied to the other of the control semiconductor integrated circuits in series through the third wiring pattern.

34. The electronic circuit according to claim 33, wherein the wiring patterns are ITO wiring patterns.

35. The electronic circuit according to claim 34, wherein the substrate is made of glass or polyethylene terephthalate.

36. The electronic circuit according to claim 33, wherein: each of the control semiconductor integrated circuits includes: a first external interface circuit coupled to the first wiring pattern; a processing circuit for processing processing data supplied from the first external interface circuit; a storage circuit capable of holding the initialization data; a control circuit controlling the operation of the processing circuit on the basis of the initialization data held by the storage circuit; and a second external interface circuit having a first interface terminal group and a pair of second interface terminal groups as external terminals of the control semiconductor integrated circuit; the second external interface circuit of the predetermined one of the control semiconductor integrated circuits selects a first initializing operation of writing initialization data input from the second wiring pattern to the first interface terminal group into the storage circuit and outputting the initialization data from the second interface terminal groups to the third wiring pattern, and the second external interface circuits of the other of the control semiconductor integrated circuits select a second initializing operation of writing initialization data input from the third wiring pattern to one of the second interface terminal groups into the storage circuit and outputting the initialization data from the other of the second interface terminal groups to the third wiring pattern.

37. The electronic circuit according to claim 36, wherein each of the control semiconductor integrated circuits has a first mode terminal which is an external terminal, and the second external interface circuit selects the first initializing operation or the second initializing operation according to the state of the first mode terminal.

38. The electronic circuit according to claim 37, wherein: the second external interface circuit includes a first extension interface terminal group and a second extension interface terminal group as the pair of second interface terminal groups; and the predetermined one of the control semiconductor integrated circuits which has selected the first initializing operation outputs the system interface information from both of the first extension interface terminal group and the second extension interface terminal group to the third wiring pattern.

39. The electronic circuit according to claim 38, wherein the third wiring pattern coupled to each of the first extension interface terminal group and second extension interface terminal group of one of the control semiconductor integrated circuits is divided between the first extension interface terminal group and the second extension interface terminal group.

40. The electronic circuit according to claim 39, wherein: each of the control semiconductor integrated circuits has a second mode terminal which is an external terminal; and each of the control semiconductor integrated circuits selects a state that initialization data is input from the first extension interface terminal group and the input initialization data is output from the second extension interface terminal group, or a state that initialization data is input from the second extension interface terminal group and the input initialization data is output from the first extension interface terminal group.
